(19) United States
(12) Patent Application Publication
(10) Pub. No.: US 2003/0108305 A1
(43) Pub. Date: Jun. 12, 2003

(54) Device for connecting one or more optical fibres to an optical converter

(76) Inventors: Peter Lo Curzio, Hudiksvall (SE); John Eriksson, Matfors (SE); Gojko Radojevic, Jarfalla (SE)

Correspondence Address: Nixon & Vanderhye, 8th Floor, 1100 North Glebe Road, Arlington, VA, 22201-4714, US

(21) Appl. No.: 10/203,093

(22) PCT Filed: Feb. 6, 2001
(86) PCT No.: PCT/SE01/00221

(30) Foreign Application Priority Data
Feb. 7, 2000 (SE) 00000374-9

(51) Int. Cl. G02B 6/42

(52) U.S. Cl. 385/92; 385/135

(57) ABSTRACT

The present invention relates to a device for connecting one or more optical fibres to an optical converter. The device is preferably conceived for use in apartment buildings and office blocks, where connection points in fibre optic networks LAN and other types of fibre optic communications networks are required for connecting optical fibres to electronic equipment. In order to simplify optical fibre installation work, the optical fibre installation is terminated in a junction box, switch box, wall terminal box (1) or some corresponding element in which any optical fibre excess (5) and connectors (6) fitted to said optical fibre can be coiled and stored in the box When the optical fibre (2) is to be connected to an optical converter (3), the converter is connected directly to (he box and the contact devices (6) on the optical fibre are brought into contact with the contact devices of the converter. The box may cover the converter either completely or partially, or the converter may comprises an integral part of the box.

### FIELD OF INVENTION

The present invention relates to a device for connecting one or more optical fibres to an optical converter. In spaces, e.g. rooms, in which devices or apparatus that include electronic equipment shall be connected to optical fibres, the devices or apparatus are first connected to a converter for converting electrical signals to optical signals, whereafter the converter is connected to one or more optical fibres. The device is preferably conceived for use in apartment blocks and office blocks where connection points are required in fibre optic networks of the LAN-type (Local Area Networks) and the FTTH-type (Fiber To The Home), and other types of fibre optic communications networks and installations for the connection of optical fibres to electronic equipment.

### BACKGROUND OF THE INVENTION

When connecting devices that include electronic equipment to optical fibres in spaces, or rooms, in dwelling houses and office premises, optical fibres extending from the optical converters of such devices are connected in wall-installed outlets to optical fibres extending from an optical fibre network, said optical fibres having been blown or drawn through ducts to the wall-installed outlets in respective spaces. In the case of fibre optic installations, an optical fibre is most often terminated in a fibre optic wall-installed outlet. A fibre optic conductor that has been provided with a circuit contact element is then connected to said wall-installed outlet, said conductor being, in turn, connected to the optical converter. Although this is a highly flexible solution. it, nevertheless, has several significant drawbacks. The fibre optic conductor is expensive and considerably increases the cost of each connected link. Moreover, the conductor is very often bulky and easily damaged.

### SUMMARY OF THE INVENTION

In the case of many fibre optic installations, for instance in dwellings, it is possible that although a large number of fibre optic connecting devices will be installed, only some of them will be connected initially to an electrooptic converter. It must be possible to connect electrooptic converters easily when the need arises, and also to disconnect converters when an associated link shall not be used. Typical examples in this respect are FTTH installations (Fibre To The Home). where entire apartment blocks and the like shall be connected to optical fibre networks with the aid of optical fibres. Initially, however, only a few households subscribe to a service offered in the fibre optic network. It would therefore be more cost-effective to install electrooptic converters solely in the dwelling places of those people who subscribe to a service. It shall also be a simple matter to remove such equipment from a dwelling place, for instance in the event of a tenant moving house so to speak. The same principles may also be applied in respect of LAN installations. The flexibility desired may be achieved, for instance, by using a separate connector-equipped optical fibre in accordance with the above. A solution to the problem may be to exclude the extra optical fibre and to connect the electrooptic converter directly to the connector-equipped optical fibre drawn into a junction box. although such a solution would result in the flexibility problems described above.

Consequently, with the intention of simplifying the installation of optical fibres in dwelling places and office premises for example, it is proposed that the optical fibres to be installed are terminated in a junction box or wall terminal box. The optical fibres will normally be fitted with connectors or circuit contacts, and any fibre excess, with its fibre-fitted connector, is coiled and placed in the box for storage purposes, where it remains for as long as the fibre link is not in use. The junction box may be provided on one side with an opening that can be closed with a blind plug. When the connection shall be used actively, the blind plug is removed and an electrooptic converter, so-called media converter. is fitted flush with this side of the box and the connector is connected. Alternatively, a further optical fibre connection can be made. As will be understood, the junction box may cover the electrooptic converter either completely or partially, or the converter may comprise an integral part of the box.

The present invention solves the following problems:

1. No extra optical fibres are required, and the cost of each connection can be reduced considerably.

2. When no electrooptic converter is fitted, optical fibres and circuit connectors are fully protected against dust and rough treatment, among other things.

3. Electrooptic converters can be connected readily and quickly without requiring the provision of a bulky and expensive built-in structure to protect the optical fibre and connector.

The invention will now be described in more detail with reference to preferred embodiments thereof and also with reference to the accompanying drawing.

### BRIEF DESCRIPTION OF THE DRAWING

FIGS. 1 and 2 are respectively a front view and a side view of a non-connected optical fibre junction box.

FIG. 3 shows the optical fibre junction box in FIGS. 1 and 2 connected to a circuit contacted electrooptic converter.

### DESCRIPTION OF PREFERRED EMBODIMENTS

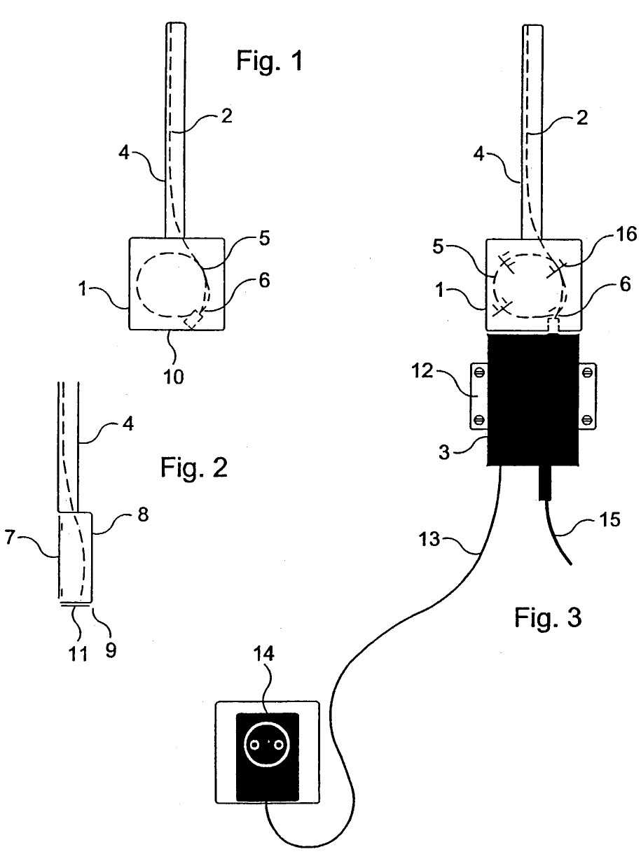

Illustrated in FIGS. 1 and 2 is a junction box or terminal box 1 for the connection of one or more optical fibres 2 or an optical cable to an electrooptic converter 3. Optical fibres taken from an optical fibre network are drawn by suction into or blown through an optical fibre duct 4 or an optical fibre channel and connected to the junction box. wherein a loop or coil 5 of optical fibres and connectors 6 fitted to the optical fibres have been disposed in the box. Optical fibre ducts or optical fibre channels will preferably have been placed in walls of appropriate spaces or rooms. whereas junction boxes or terminal boxes have preferably been placed on the walls that define one or more spaces, such as one or more rooms in a dwelling. The box may consist of a back piece 7, for mounting the box on a wall, and a casing 8 or protective structure. wherewith the casing may be adapted to be pressed firmly onto the back piece in a simple fashion, so that the parts together form a fixed and protective optical fibre junction box. Provided in the bottom edge 9 of the junction box, either on the back piece or on the actual casing itself, is a closeable opening 10 via which connectors on the optical fibres can be connected to the electrooptic converter. The opening may be covered by a removable cover 11 or by a cover pivotally mounted on the back piece or the casing.

FIG. 3 illustrates the connection of a media converter or a so-called electrooptic converter 3 to the junction box 1 and also shows a connector fitted to the optical fibre in connection with the optical connector on the converter, said converter being shown attached to the wall beneath the junction box with the aid of a wall mounting plate 12. Alternatively, the junction box and the converter may include respective connecting or contact devices that enable the converter to be connected directly to the junction box. It will preferably be possible to join the box and the converter together, by exerting a light pressure thereon. Depending on the construction of the junction box and the converter, the connectors on the optical fibres can be connected to corresponding connectors on the converter at the same time as the box and converter are brought into contact with one another. The converter is also provided with a current supply lead/contact 13, for instance extending from a transformer 14 hanging from a wall outlet and a connection lead/contact 15 for connection to a computer or similar connection. Alternatively, the junction box itself may include a contact connection for supplying current to the converter, wherewith when the converter and the junction box are in mutual contact current will be supplied to the converter through the contact established by the connectors. The back piece may include means 16 within the junction box for forming one or more optical fibre loops in said box prior to connecting the optical fibres and establishing electrical contact with the converter. The junction box is preferably made of plastic material.

It will be understood that the invention is not restricted to the described and illustrated embodiment, and that modifications can be made within the scope of the accompanying Claims.

1. A device for connecting an electrooptic converter to at least one optical fibre comprising at least one connection for an optical fibre and a second connection for the electrooptic converter, characterised in that the device includes a protective space (1) for the optical fibre (2) and its connector (6) for connecting of the optical fibre to a contact device of the electrooptic converter, in that the protective space is adapted to receive the optical fibre (2) from an optical fibre channel or the like terminating in the protective space and in that the electrooptic converter is adapted for arrangement adjacent to the protective space (1) for its connection to the protective space and simultaneous contact of the connector of the optical fibre to the optical contact device on said converter, wherein preferably said converter forms when mounted, an integrated part of the protective space.

2. A device according to claim 1, characterised in that the protective space has the form of a junction box or terminal box (1), that includes a back piece (7) and a casing (8) and in that the protective space is adapted to be mounted on a supported surface such as a wall structure.

3. A device according to claim 1, characterised in that the protective space includes an opening (10) for insertion of the contact device of the converter (3) when connecting the contact device to the connector.

4. A device according to claim 3, characterised by a cover (11) that functions to close the opening (10) in the case of a non-connected contact device.

5. A device according to claim 1, characterised in that the protective space (1) has a connection point for current supply to the converter (3), wherein contact of the protective space with the converter results in simultaneous contact with the connector of the optical fibre to the optical contact device on the converter and contact of the current supply to said converter.
